(19) United States
(12) Patent Application Publication
(10) Pub. No.: US 2025/0336136 A1
(43) Pub. Date: Oct. 30, 2025

(54) IMAGE PROCESSING METHOD AND APPARATUS, DEVICE, AND STORAGE MEDIUM

(71) Applicant: Beijing Zitiao Network Technology Co., Ltd., Haidian District, Beijing (CN)

(72) Inventors: Jiaxin Ma, Beijing (CN); Chun Liu, Beijing (CN); Weiying Liu, Beijing (CN); Mengyun He, Beijing (CN)

(21) Appl. No.: 18/866,691

(22) PCT Filed: May 15, 2023
(86) PCT No.: PCT/CN2023/094297

§ 371 Date: Nov. 18, 2024

(30) Foreign Application Priority Data
May 18, 2022 (CN) 202210551443.4

(51) Int. Cl. G06T 15/00

(52) U.S. Cl. CPC G06T 15/005

(57) ABSTRACT

Provided are an image processing method, a device, and a storage medium. The method includes: taking, in response to detecting an operation triggered by a user, a screenshot of a current picture so as to obtain an initial image; transmitting the initial image to a server to cause the server to perform first effect processing on the initial image, and rendering a material onto the current picture for display; and receiving a first effect image transmitted by the server, and rendering the first effect image onto the current picture for display, where the first effect image is an image obtained after the server performs the first effect processing on the initial image.

### CROSS-REFERENCE TO RELATED APPLICATION(S)

The disclosure claims the benefit of priority to Chinese Patent Application No. 202210551443.4, filed with the Chinese Patent Office on May 18, 2022, which is incorporated herein in its entirety by reference.

### FIELD

Embodiments of the disclosure relate to the technical field of image processing, and relate to a method and apparatus for processing an image, a device, and a storage medium for example.

### BACKGROUND

At present, a mobile terminal has become an indispensable entertainment tool for users. The user can process images with the mobile terminal in various ways. In the related art, only local algorithms of clients can be run in most cases when the images are processed. Due to limitations of hardware configuration of the mobile terminal, the efficiency of image processing is low, and processed images have poor accuracy. Thus, an image processing effect is affected.

### SUMMARY

Embodiments of the disclosure provide an image processing method and apparatus, a device, and a storage medium. An initial image is transmitted to a server for effect processing, such that not only the data processing workload of a client can be reduced, but also the effect of effect processing of an image can be improved.

In a first aspect, an embodiment of the disclosure provides an image processing method. The method includes:

taking, in response to detecting an operation triggered by a user, a screenshot of a current picture so as to obtain an initial image;

transmitting the initial image to a server to cause the server to perform first effect processing on the initial image, and rendering an material onto the current picture for display; and

receiving a first effect image transmitted by the server, and rendering the first effect image onto the current picture for display, where the first effect image is an image obtained after the server performs the first effect processing on the initial image.

In a second aspect, an embodiment of the disclosure further provides an image processing apparatus. The apparatus includes:

an initial image obtaining module, configured to take, in response to detecting an operation triggered by a user, a screenshot of a current picture so as to obtain an initial image;

an initial image transmission module, configured to transmit the initial image to a server to cause the server to perform first effect processing on the initial image, and render a material onto the current picture for display; and

a first effect image display module, configured to receive a first effect image transmitted by the server, and render the first effect image onto the current picture for display, where the first effect image is an image obtained after the server performs the first effect processing on the initial image.

In a third aspect, an embodiment of the disclosure further provides an electronic device. The electronic device includes:

one or more processors; and

a storage apparatus, which is configured to store one or more programs.

The one or more programs, when executed by the one or more processors, cause the one or more processors to implement the method for processing an image according to any of claims 1-9.

In a fourth aspect, an embodiment of the disclosure further provides a storage medium including a computer-executable instruction. The computer-executable instruction, when executed by a computer processor, is configured to execute the image processing method in the embodiment of the disclosure.

### BRIEF DESCRIPTION OF THE DRAWINGS

The same or similar reference numerals refer to the same or similar elements throughout the figures. It should be understood that the figures are illustrative, and components and elements are not necessarily drawn to scale.

FIG. 1 is a schematic flow diagram of an image processing method according to an embodiment of the disclosure;

FIG. 2a is an example diagram of a material according to an embodiment of the disclosure;

FIG. 2b is an example diagram of a material according to an embodiment of the disclosure;

FIG. 3 is a schematic structural diagram of an image processing apparatus according to an embodiment of the disclosure; and

FIG. 4 is a schematic structural diagram of an electronic device according to an embodiment of the disclosure.

### DETAILED DESCRIPTION OF EMBODIMENTS

Embodiments of the disclosure will be described in more detail below with reference to accompanying drawings. Although some embodiments of the disclosure are shown in the accompanying drawings, it should be understood that the disclosure can be implemented in various forms. These embodiments are provided such that the disclosure can be understood more thoroughly and completely. It should be understood that accompanying drawings and embodiments of the disclosure are for exemplary purposes only.

It should be understood that various steps recited in method implementations of the disclosure can be executed in different orders and/or in parallel. In addition, the method implementations can include additional steps and/or omit to execute shown steps.

The terms “comprise”, “include” and their variations are open-ended, that is, “comprising but not limited to” and “including but not limited to”. The term “based on” is “at least partially based on”. The term “an embodiment” represents “at least one embodiment”, the term “another embodiment” represents “at least one other embodiment”, and the term “some embodiments” represents “at least some embodiments”. Definitions of other terms will be given in the following descriptions.

It should be noted that concepts such as “first” and “second” mentioned in the disclosure are only used for distinguishing different apparatuses, modules or units.

It should be noted that modifications of “a”, “an” and “plurality of” mentioned in the disclosure are illustrative. Those skilled in the art should understand that these modifications should be understood as “one or more”, unless explicitly stated otherwise in the context.

The names of messages or information exchanged between a plurality of apparatuses in implementations of the disclosure are for illustrative purposes only.

It can be understood that before the technical solutions disclosed in various embodiments of the disclosure are used, the user should be informed of the type, usage scope, usage scenario, etc. of personal information involved in the disclosure in an appropriate manner according to relevant laws and regulations, and authorization from the user should be obtained.

For example, in response to determining that an active request of a user is received, reminding information is transmitted to the user to explicitly remind the user that an operation requested to be executed by the user will need to acquire and use the personal information of the user. Therefore, the user can autonomously choose, according to the reminding information, whether to provide personal information to software or hardware, such as an electronic device, an application, a server or a storage medium that executes an operation of the technical solution of the disclosure.

As an optional implementation, in response to determining that the active request of the user is received, the reminding information may be transmitted to the user by means of a pop-up window, or through other methods. The reminding information may be presented in the pop-up window in a text manner. In addition, the pop-up window may also carry a choice control for the user to choose to “agree” or “disagree” to provide the personal information for the electronic device.

It can be understood that the above notification and user authorization acquisition processes are merely illustrative, and other manners satisfying relevant laws and regulations may also be applied to the implementation of the disclosure.

It can be understood that data involved in the technical solution (including the data, and acquisition or use of the data) shall comply with requirements of corresponding laws, regulations and relevant regulations.

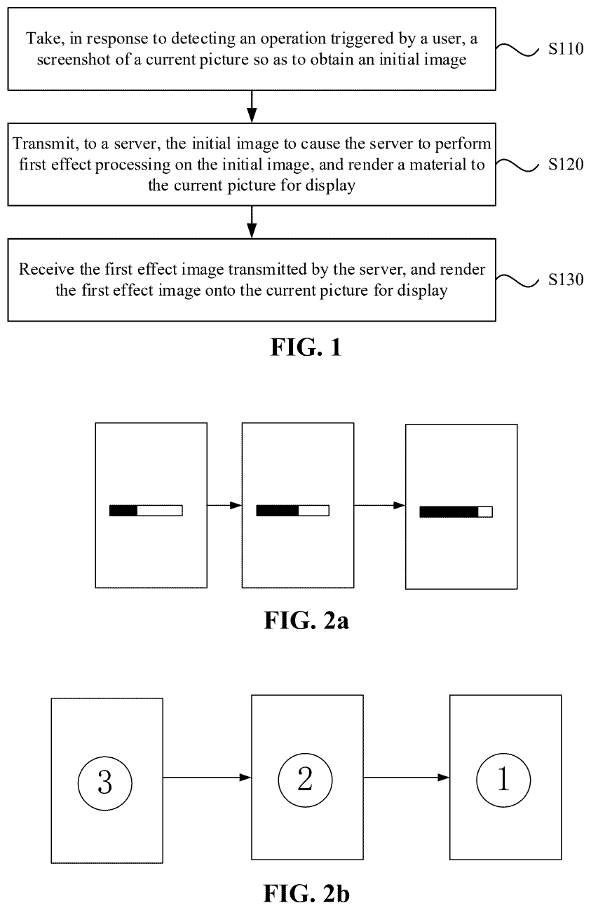

FIG. 1 is a schematic flow diagram of an image processing method provided in an embodiment of the disclosure. The embodiment of the disclosure is applicable to the situation of processing an image. The method may be executed by an image processing apparatus. The apparatus may be implemented in the form of software and/or hardware, or alternatively, implemented by an electronic device. The electronic device may be a mobile terminal, a personal computer (PC) terminal or a server.

As shown in FIG. 1, the method includes:

S110: taking, in response to detecting an operation triggered by a user, a screenshot of a current picture so as to obtain an initial image.

The operation may be an operation of clicking on a screen, an operation of double-clicking on a screen, an operation of detecting a gesture or posture made by a user, an operation of collecting a voice signal including a keyword, etc. Taking the screenshot can also be referred to as a screen capture. By invoking a screenshot taking function, a screenshot is taken from the content displayed on a current picture, such that the initial image is obtained.

In the embodiment, when the terminal device turns on an image processing prop, the terminal device displays an image currently collected by a camera on the current picture in real-time, or acquires a video file from a local database or a network database and plays the video file on the current interface. When the terminal device detects the operation triggered by the user, a screenshot is taken the content displayed on the current picture, and the initial image is obtained.

Optionally, before taking a screenshot of the current picture, the method further includes: running a beautification program package to beautify a collected image; and rendering the beautified image onto the current picture.

The beautification program package may be a program package that performs beautification processing on an image. The input of the beautification program package is an image, and the output is a beautified image. If the image is a face image, the beautification program package may be a program package for beauty makeup. If the image is a landscape image, the beautification program package may be a program package for adjusting hue and/or saturability. Herein, the beautification program package may be a packaged program package having a beautification function. The user chooses settings according to requirements after opening the image processing toolkit.

In the embodiment, after the beautification program package is run, the image collected by a camera is beautified, and the beautified image is rendered onto the current picture. Correspondingly, taking a screenshot of the current picture includes: taking a screenshot of the beautified image in the current picture. In the embodiment, the image is beautified first, such that the screenshot can be taken from the beautified image, and the display effect of the image can be improved.

S120: Transmitting the initial image to a server to cause the server to perform first effect processing on the initial image, and rendering a material onto the current picture for display.

In the embodiment, the client transmits the initial image to the server. The server invokes an effect algorithm configured on the server to perform the first effect processing on the initial image, thereby obtaining the first effect image. Then, the server returns the first effect image to the client.

Optionally, transmitting the initial image to a server to cause the server to perform first effect processing on the initial image may include: transmitting the initial image carrying an algorithm identifier to the server, to cause the server to invoke a target effect algorithm according to the algorithm identifier to the first effect processing on the initial image using the target effect algorithm.

The algorithm identifier may be composed of information such as an algorithm name and an algorithm storage address. The target effect algorithm may be a constructed neural network model, such as generative adversarial nets (GAN). In the embodiment, different effect functions correspond to different effect processing algorithms. One or more effect processing algorithms may be set on the server for one image processing prop. The user chooses the required effect processing algorithm. Illustratively, an effect function may be to perform effect processing on a region in an image, for example, perform a hairstyle change (including a change of at least one of a hair length, a hair color and a hair styling) on a portrait in an original image, and perform stylization processing on the original image (for example, convert the style to a sketch style, a simple stroke style, or an opera facial makeup style). In the embodiment, the target effect algorithm is invoked through the algorithm identifier such that the first effect processing can be accurately performed on the initial image.

In the embodiment, after the client transmits the initial image to the server, due to the influence of a network condition and the requirement of time for running the target effect algorithm, the time for the server to return the image subjected to effect processing is uncertain. In the period between the time when the initial image is transmitted and the time when the first effect image is received, the material may be rendered onto the current picture for display.

The preset material may be a video file composed of a sequence of material images, that is, composed of a plurality of material images. A material image may be an image preset by the developer, or may be a sequence of material images for timing. For example, the sequence of material images may be a sequence of material images in the form of a progress bar, a sequence of material images in the form of a countdown, or a sequence of material images combining a countdown and a progress bar. Illustratively, FIGS. 2A and 2b are example diagrams of materials. As shown in FIG. 2a, the materials are displayed in the form of a progress bar. From left to right, the progress of the progress bar advances as time advances. As shown in FIG. 2b, the materials are displayed in the form of s countdown. From left to right, the number in the material images gradually decreases as time advances.

In the embodiment, the process of rendering the material onto the current picture for display may include: rendering the sequence of material images onto the current picture sequentially for display.

The material image sequences are arranged in a certain order. The material images are sequentially read according to the order. The read material images are rendered onto the current picture for slow display. In the embodiment, after the initial image is transmitted to the server, the material is rendered onto the current picture for display. In this way, the problem that relatively monotonous content is displayed on the current picture can be avoided, and image processing can be more interesting.

S130: Receiving the first effect image transmitted by the server, and rendering the first effect image onto the current picture for display.

The first effect image is an image obtained after the server performs the first effect processing on the initial image. In the embodiment, after the server completely performs first effect processing on the initial image, the first effect image is obtained. Then, the first effect image is returned to the client, such that the client displays the first effect image.

Optionally, receiving the first effect image transmitted by the server, and rendering the first effect image onto the current picture for display may include: continue, in response to determining that the material is not completely displayed when the first effect image transmitted by the server is received, to render the material onto the current picture; and render, in response to determining that the material is completely displayed, the first effect image onto the current picture for display.

In the embodiment, since the material is composed of a sequence of material images, it takes a certain duration to completely display all the sequence of material images, such as any duration between 2 seconds and 5 seconds. If the current network state is desirable, the server can return the first effect image to the client in a short time, and the material may not be completely displayed. In this case, the remaining material images are continued to be rendered sequentially onto the current picture for display until the material is completely displayed, and then the first effect image is rendered onto the current picture for display. In the embodiment, the material is completely displayed such that continuity of the content displayed on the picture can be ensured. Therefore, the first effect image can be prevented from being abruptly displayed on the current picture, and the viewing experience of a user can be improved.

Optionally, in response to determining that the material is not completely displayed when the first effect image transmitted by the server is received, the material is stopped from being rendered, and the first effect image is rendered onto the current picture for display.

If the current network state is desirable, the server can return the first effect image to the client in a short time, and the material may not be completely displayed. In this case, the remaining material images are stopped from being rendered, and the first effect image is directly rendered onto the current picture for display. According to the solution of the embodiment, the first effect image can be displayed on the current picture in time, and the waiting time of the user can be shortened.

Optionally, receiving the first effect image transmitted by the server, and rendering the first effect image onto the current picture for display, may include: in response to determining that the first effect image transmitted by the server is not received when the material is completely displayed, keeping the current picture still at the material for a duration, or acquiring the material again and displaying the material for the duration on the current picture; and render, in response to determining that the first effect image transmitted by the server is received within the duration, the first effect image onto the current picture for display.

The duration may be shorter than the full display duration of the material. For example, any duration between 2 seconds and 3 seconds may be set. The case that the current picture is kept still at the material for the duration can be understood as a case that the current picture is stopped at the last material image of the material for a duration. The case that the material is re-acquired and the material is displayed on the current picture for the duration can be understood as a case that the material image is read from the first material image of the material for the duration, or the material image is randomly read from the material for the duration, and the read material image is rendered onto the current picture for display. Within the duration, in response to determining that the client receives the first effect image transmitted by the server, the first effect image is rendered onto the current picture for display.

In the embodiment, if the current network state is poor, the client may still not have received the first effect image returned by the server when the material is completely displayed, and waits for a duration at this time. If the client receives the first effect image transmitted by the server within the duration, the first effect image is rendered onto the current picture for display. In a case that when the material is completely displayed, the first effect image transmitted by the server is still not received, wait is continued to be performed for a duration, such that it is ensured that the server-processed image is displayed on the current picture as much as possible.

Optionally, after keeping the current picture still at the material for a duration, or acquiring the material again, and displaying the material for the duration on the current picture, the method further includes: in response to determining that the first effect image transmitted by the server is not received within the duration, rendering the initial image onto the current picture for display or display information on the current picture.

The information may be information indicating that the first effect image returned by the server is not received, such as “processing failure”. In the embodiment, when the first effect image is not received, the initial image is rendered onto the current picture for display, or information is displayed on the current picture, and a content displayed on the current picture is ensured.

Optionally, after the step of obtaining an initial image, the method further includes: performing second effect processing on the initial image so as to obtain a second effect image; and rendering, in response to determining that the first effect image transmitted by the server is not received within the duration, the second effect image onto the current picture for display.

In the embodiment, the client performs the second effect processing on the initial image by invoking a local effect processing algorithm. The local effect processing algorithm has lower precision and occupies fewer system resources than the effect processing algorithm at the server.

In an embodiment, performing second effect processing on the initial image so as to obtain a second effect image includes: dividing a region in the initial image so as to obtain a sub-region; and performing the second effect processing on the sub-region so as to obtain the second effect image.

The second effect processing may be a processing manner corresponding to the first effect processing. For example, if the first effect processing is effect processing of “hairstyle change”, the second effect processing may be hair dyeing.

The process of dividing a region in the initial image so as to obtain a sub-region may be as follows: semantic recognition is performed on the region first so as to obtain a mask of the region. The region is divided from the initial image by using the mask. The sub-region corresponding to the region is obtained. After the sub-region is obtained, the second effect processing is performed on the sub-region. Then, the sub-region subjected to the second effect processing is fused with the initial image, such that a second effect image is obtained. Illustratively, assuming that the second effect processing is hair dyeing, the process of performing the second effect processing on the initial image may be as follows: hair recognition is performed on the initial image first, such that a hair mask is obtained. A hair region is divided from the initial image by using the hair mask. Then, a color is obtained. The color is mixed with an original color of hair, thereby a target color is obtained. The target color is determined as the final color of each pixel point of the hair region. Finally, the dyed hair region is fused with the initial image, thereby a second effect image is obtained, such that the hair is dyed. In the embodiment, if the first effect image transmitted by the server is not received within the duration, the second effect image processed by the client is displayed on the current picture, such that image processing is ensured, and user experience is prevented from being affected.

Optionally, after rendering the first effect image onto the current picture for display, the method further includes: causing, in response to detecting that a user clicks a resume button, the current picture to return to display an image collected by a camera in real-time; and continuing to detect the operation triggered by the user.

Illustratively, the embodiment may be used for an application scenario of performing effect processing of “hair change” on a portrait in an image. The specific process is as follows: after a user starts an image processing tool through a mobile terminal, a beautification program package is run. The mobile terminal beautifies a collected image and displays the beautified image on a current picture in real-time. When the user triggers an operation, the mobile terminal takes a screenshot of a content displayed on the current picture so as to obtain an initial image. The client transmits the initial image to the server, such that the server performs effect processing of “hair change” on the portrait in the initial image. Meanwhile, the client performs effect processing of “hair dyeing” on the portrait in the initial image. After the client takes the screenshot of the current picture, the material is displayed on the current picture for display. In a case that the client receives the first effect image returned by the server when the material is completely displayed, the first effect image is rendered onto the current picture for display. If the client does not receive the first effect image returned by the server, the client continues to wait for a duration. If the client receives the first effect image returned by the server within the duration, the first effect image is rendered onto the current picture for display. If the first effect image returned by the server is still not received after the duration, the second effect image processed by the client is rendered onto the current picture for display.

According to an embodiment of the disclosure, in response to detecting an operation triggered by a user, a screenshot is taken from a current picture, and an initial image is obtained. The initial image is transmitted to a server, and the server is caused to perform first effect processing on the initial image. A material is rendered onto the current picture for display. A first effect image transmitted by the server is received, and the first effect image is rendered onto the current picture for display. The first effect image is an image obtained after the server performs the first effect processing on the initial image. According to the method for processing an image provided in an embodiment of the disclosure, an initial image obtained by taking a screenshot is transmitted to a server for effect processing, such that not only data processing workload of a client can be reduced, but also an effect of effect processing of an image can be improved.

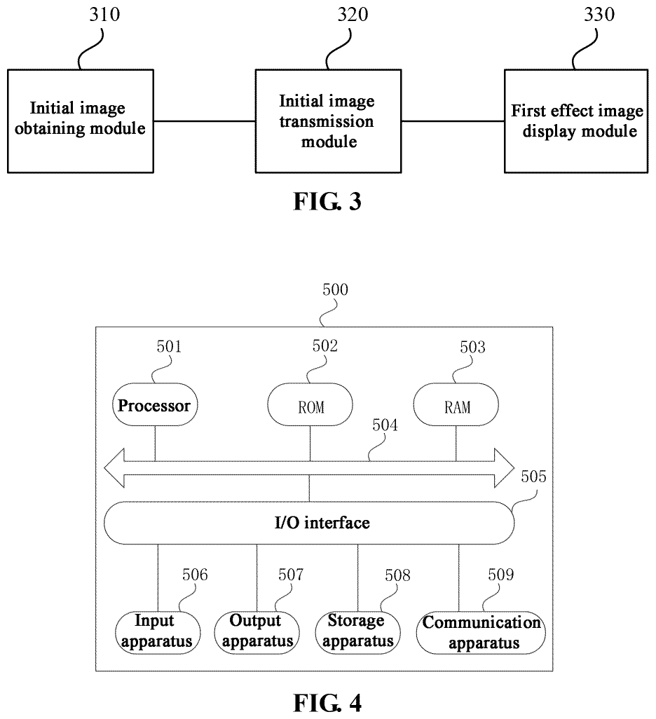

FIG. 3 is a schematic structural diagram of an image processing apparatus for according to an embodiment of the disclosure. As shown in FIG. 3, the apparatus includes:

an initial image obtaining module 310, which is configured to take, in response to detecting an operation triggered by a user, a screenshot of a current picture so as to obtain an initial image;

an initial image transmission module 320, which is configured to transmit the initial image to a server to cause the server to perform first effect processing on the initial image, and render a material onto the current picture for display; and

a first effect image display module 330, which is configured to receive a first effect image transmitted by the server, and render the first effect image onto the current picture for display, where the first effect image is an image obtained after the server performs the first effect processing on the initial image.

Optionally, an initial image transmission module 320 is configured to transmit the initial image to the server to cause the server to perform first effect processing on the initial image using methods as follows:

transmit the initial image carrying an algorithm identifier to the server, to cause the server to invoke a target effect algorithm according to the algorithm identifier to perform the first effect processing on the initial image through the target effect algorithm.

Optionally, the material is composed of a sequence of material images. The apparatus further includes a material rendering module configured to:

render the sequence of material images onto the current picture sequentially for display.

Optionally, the first effect image display module 330 is configured to receive the first effect image transmitted by the server and render the first effect image onto the current picture for display as follows:

continue, in response to determining that the material is not completely displayed when the first effect image transmitted by the server is received, to render the material onto the current picture; and

render, in response to determining that the material is completely displayed, the first effect image onto the current picture for display.

Optionally, the first effect image display module 330 is configured to receive the first effect image transmitted by the server and render the first effect image onto the current picture for display as follows:

in response to determining that the material is not completely displayed when the first effect image transmitted by the server is received, stop rendering the material, and render the first effect image onto the current picture for display.

Optionally, the first effect image display module 330 is configured to receive the first effect image transmitted by the server and render the first effect image onto the current picture for display as follows:

in response to determining that the first effect image transmitted by the server is not received when the material is completely displayed, keep the current picture still at the material for a duration, or acquire the material again and display the material for the duration on the current picture; and

render, in response to determining that the first effect image transmitted by the server is received within the duration, the first effect image onto the current picture for display.

Optionally, the first effect image display module 330 is configured to receive the first effect image transmitted by the server, and render the first effect image onto the current picture for display as follows:

in response to determining that the first effect image transmitted by the server is not received within the duration, render the initial image onto the current picture for display or display information on the current picture.

Optionally, the apparatus further includes a second effect image display module configured to:

perform second effect processing on the initial image so as to obtain a second effect image; and

render, in response to determining that the first effect image transmitted by the server is not received within the duration, the second effect image onto the current picture for display.

Optionally, the second effect image display module is configured to perform second effect processing on the initial image so as to obtain a second effect image through methods as follows: divide a region in the initial image so as to obtain a sub-region; and

perform the second effect processing on the sub-region so as to obtain a second effect image.

Optionally, the apparatus further includes a beautification module configured to:

run a beautification program package to beautify a collected image; and

render the beautified image onto the current picture.

Optionally, the initial image obtaining module 310 is configured to take the screenshot of a current picture through a method as follows:

take a screenshot of the beautified image in the current picture.

The image processing apparatus provided in an embodiment of the disclosure can execute the method for processing an image provided in any embodiment of the disclosure, and has corresponding functional modules and beneficial effects for executing the method.

It is worth noting that all the units and modules included in the above apparatus are divided merely according to a functional logic, and actual division is performed as long as the corresponding functions can be realized. In addition, a particular name of each functional unit is merely for the convenience of mutual distinguishing.

FIG. 4 is a schematic structural diagram of an electronic device according to an embodiment of the disclosure. With reference to FIG. 4 below, a schematic structural diagram of an electronic device 500 (such as the terminal device or server in FIG. 4) applicable to implementing an embodiment of the disclosure is shown in the figure. The terminal device in an embodiment of the disclosure may include a mobile phone, a notebook computer, a digital broadcast receiver, a personal digital assistant (PDA), a portable android device (PAD), a portable media player (PMP), an in-vehicle terminal (such as an in-vehicle navigation terminal) and other mobile terminals, and a stationary terminal such as a digital television (TV) and a desktop computer. The electronic device shown in FIG. 4 is merely an example.

As shown in FIG. 4, the electronic device 500 may include a processor (such as a central processing unit and a graphics processor) 501 that may execute various appropriate actions and processing according to programs stored in a read only memory (ROM) 502 or loaded into a random access memory (RAM) 503 from a storage apparatus 508. In the RAM 503, various programs and data required for operations of the electronic device 500 are also stored. The processor 501, the ROM 502 and the RAM 503 are connected to each other by means of a bus 504. An input/output (I/O) interface 505 is also connected to the bus 504.

Generally, the following apparatuses may be connected to the I/O interface 505: an input apparatus 506 such as a touch screen, a touch pad, a keyboard, a mouse, a camera, a microphone, an accelerometer and a gyroscope, an output apparatus 507 such as a liquid crystal display (LCD), a speaker and a vibrator, a storage apparatus 508 such as a magnetic tape and a hard disk, and a communication apparatus 509. The communication apparatus 509 may allow the electronic device 500 to be in wireless or wired communication with other devices for data exchange. Although FIG. 4 shows an electronic device 500 having various apparatuses, it should be understood that not all of the shown apparatuses are required to be implemented or provided. More or fewer apparatuses may be alternatively implemented or provided.

In particular, according to an embodiment of the disclosure, the process described above with reference to a flow diagram may be implemented as a computer software program. For instance, an embodiment of the disclosure includes a computer program product. The computer program product includes a computer program carried on a non-transitory computer-readable medium, and the computer program includes a program code for executing the method shown in the flow diagram. In such an embodiment, the computer program may be downloaded and mounted from a network by means of the communication apparatus 509, mounted from the storage apparatus 508, or mounted from the ROM 502. When executed by the processor 501, the computer program executes the above functions defined in a method in an embodiment of the disclosure.

The names of messages or information exchanged between a plurality of apparatuses in implementations of the disclosure are for illustrative purposes only.

The electronic device provided in an embodiment of the disclosure and the method for processing an image provided in the above embodiment belong to the same inventive concept. Reference can be made to the above embodiment for technical details not described in detail in the embodiment. Moreover, the embodiment has the same beneficial effects as the above embodiment.

An embodiment of the disclosure provides a computer-readable storage medium. The computer-readable storage medium stores a program, and the program implements the method for processing an image provided in the above embodiment when executed by a processor.

It should be noted that the above computer-readable medium in the disclosure may be a computer-readable signal medium, a computer-readable storage medium, or their combinations. The computer-readable storage medium may be an electronic, magnetic, optical, electromagnetic, infrared or semiconductor system, apparatus or device, or any combinations of the foregoing. The computer-readable storage medium may include an electrical connection having one or more wires, a portable computer disk, a hard disk, an RAM, an ROM, an erasable programmable read-only memory (EPROM or a flash memory), an optical fiber, a portable compact disk read-only memory (CD-ROM), an optical storage device, a magnetic storage device, or any suitable combinations of the forgoing. In the disclosure, the computer-readable storage medium may be any tangible medium including or storing a program, and the program may be used by or in connection with an instruction execution system, apparatus or device. In the disclosure, a computer-readable signal medium may include a data signal propagated in a baseband or as part of a carrier wave, and a computer-readable program code is carried in the data signal. Such a propagated data signal may employ a plurality of forms, which include an electromagnetic signal, an optical signal or any suitable combinations of the foregoing. The computer-readable signal medium may also be any computer-readable medium rather than a computer-readable storage medium, and may transmit, propagate or transmit a program that is used by or in combination with an instruction execution system, apparatus or device. The program code included in the computer-readable medium may be transmitted by means of any appropriate media, which include a wire, an optical cable, a radio frequency (RF), etc., or any suitable combinations of the foregoing.

In some implementations, a client and a server may perform communication by means of any currently-known or future-developed network protocols such as a hypertext transfer protocol (HTTP), and may be interconnected to digital data communication (such as a communication network) of any forms or media. Examples of the communication network include a local area network (LAN), a wide area network (WAN), an internetwork (such as the internet), an end-to-end network (such as an ad hoc end-to-end network), and any currently-known or future-developed networks.

The above computer-readable medium may be included in the above electronic device, and may independently exist without being assembled into the electronic device.

The above computer-readable medium carries one or more programs, and when the one or more programs are executed by the electronic device, the electronic device is caused to:

take, in response to detecting an operation triggered by a user, a screenshot of a current picture so as to obtain an initial image;

transmit the initial image to a server to cause the server to perform first effect processing on the initial image, and render a material onto the current picture for display; and

receive a first effect image transmitted by the server, and render the first effect image onto the current picture for display; where the first effect image is an image obtained after the server performs the first effect processing on the initial image.

The above computer-readable medium carries one or more programs, and when the one or more programs are executed by the electronic device, the electronic device is caused to: take, in response to detecting an operation triggered by a user, taking the screenshot of a current picture so as to obtain an initial image; transmit the initial image to a server to cause the server to perform first effect processing on the initial image, and render a material onto the current picture for display; and receive a first effect image transmitted by the server, and render the first effect image onto the current picture for display; where the first effect image is an image obtained after the server performs the first effect processing on the initial image.

The computer program code for executing an operation of the disclosure may be written in one or more programming languages or their combinations. The above programming languages include object-oriented programming languages such as Java, Smalltalk and C++, and conventional procedural programming languages such as a “C” language or similar programming languages. The program code may be entirely executed on a user computer, partially executed on the user computer, executed as a stand-alone software package, partially executed on the user computer and partially executed on a remote computer, or entirely executed on the remote computer or a server. In a case that the remote computer is involved, the remote computer may be connected to the user computer by means of any type of network, which includes a local area network (LAN) or a wide area network (WAN), or may be connected to an external computer (for example, by means of the internet by an internet service provider).

Flow diagrams and block diagrams in accompanying drawings show system architectures, functions and operations, which may be implemented according to systems, methods and computer program products in various embodiments of the disclosure. In this regard, each block in flow diagrams or block diagrams can represent a module, a program segment, or a part of a code, which includes one or more executable instructions for implementing specified logical functions. It should also be noted that in some substitutive implementations, functions noted in blocks can also occur in sequences different from those in figures. For instance, functions represented by two continuous blocks can be executed substantially in parallel in practice, and sometimes implemented in reverse sequences, which depends on the involved functions. It should also be noted that each block in flow diagrams and/or block diagrams, and combinations of the blocks in the flow diagrams and/or the block diagrams can be implemented by means of dedicated hardware-based systems that execute specified functions or operations, or can be implemented by means of combinations of dedicated hardware and computer instructions.

Units described in embodiments of the disclosure can be implemented in the form of software or hardware. In some cases, the name of the unit may be set according to actual situations. For example, the first obtaining unit may also be described as “a unit obtaining at least two internet protocol addresses”

At least some of the functions described above herein can be executed by one or more hardware logic components. For example, example types of hardware logic components that may be used include a field programmable gate array (FPGA), an application specific integrated circuit (ASIC), an application specific standard product (ASSP), a system on chip (SOC), a complex programmable logic device (CPLD), etc.

In a context of the disclosure, a machine-readable medium may be a tangible medium, which may include or store a program for being used by or in connection with an instruction execution system, apparatus or device. The machine-readable medium may be a machine-readable signal medium or a machine-readable storage medium. The machine-readable medium may include but is not limited to an electronic, magnetic, optical, electromagnetic, infrared or semiconductor system, apparatus or device, or any suitable combinations of the foregoing. The machine-readable storage medium may include an electrical connection based on one or more wires, a portable computer disk, a hard disk, an RAM, an ROM, an erasable programmable read-only memory (EPROM or a flash memory), an optical fiber, a compact disk read-only memory (CD-ROM), an optical storage device, a magnetic storage device or any suitable combinations of the foregoing.

According to one or more embodiments of the disclosure, an image processing method is provided. The method includes:

taking, in response to detecting an operation triggered by a user, a screenshot of a current picture so as to obtain an initial image;

transmitting the initial image to a server to cause the server to perform first effect processing on the initial image, and rendering a material onto the current picture for display; and

receiving a first effect image transmitted by the server, and rendering the first effect image onto the current picture for display, where the first effect image is an image obtained after the server performs the first effect processing on the initial image.

In an embodiment, transmitting the initial image to a server to the server to perform first effect processing on the initial image includes:

transmitting the initial image carrying an algorithm identifier to the server, to cause the server to invoke a target effect algorithm according to the algorithm identifier and perform the first effect processing on the initial image using the target effect algorithm.

In an embodiment, the material is composed of a sequence of material images, and

rendering a material onto the current picture for display includes:

rendering the sequence of material images onto the current picture sequentially for display.

In an embodiment, the receiving a first effect image transmitted by the server, and rendering the first effect image onto the current picture for display include:

continuing, in response to determining that the material is not completely displayed when the first effect image transmitted by the server is received, to render the material onto the current picture;

rendering, in response to determining that the material is completely displayed, the first effect image onto the current picture for display; and

in response to determining that the material is not completely displayed when the first effect image transmitted by the server is received, stopping rendering the material and rendering the first effect image onto the current picture for display.

In an embodiment, receiving a first effect image transmitted by the server, and rendering the first effect image onto the current picture for display, include:

in response to determining that the first effect image transmitted by the server is not received when the material is completely displayed, keeping the current picture still at the material for a duration, or acquiring the material again and display the material for the duration on the current picture; and

rendering, in response to determining that the first effect image transmitted by the server is received within the duration, the first effect image onto the current picture for display.

In an embodiment, the method further includes:

in response to determining that the first effect image transmitted by the server is not received within the duration, rendering the initial image onto the current picture for display or display information on the current picture.

In an embodiment, after obtaining an initial image, the method further includes:

performing second effect processing on the initial image so as to obtain a second effect image; and

rendering, in response to determining that the first effect image transmitted by the server is not received within the duration, the second effect image onto the current picture for display.

In an embodiment, performing second effect processing on the initial image so as to obtain a second effect image includes:

dividing a region in the initial image so as to obtain a sub-region; and

performing the second effect processing on the sub-region so as to obtain a second effect image.

In an embodiment, before taking a screenshot of a current picture, the method further includes:

running a beautification program package to beautify a collected image; and

render the beautified image onto the current picture; and

taking a screenshot of a current picture includes:

taking a screenshot of the beautified image in the current picture.

Although various operations are described in a specific order, it should not be understood that these operations are required to be executed in a shown specific order or in a sequential order. In certain circumstances, multitasking and parallel processing may be advantageous. Some features described in contexts of separate embodiments can also be implemented in a single embodiment in combination. Conversely, various features described in the context of a single embodiment can also be implemented in a plurality of embodiments separately or in any suitable sub-combinations.

1. An image processing method, comprising:
taking, in response to detecting an operation triggered by a user, a screenshot of a current picture so as to obtain an initial image;
transmitting the initial image to a server to cause the server to perform first effect processing on the initial image, and rendering a material onto the current picture for display; and
receiving a first effect image transmitted by the server, and rendering the first effect image onto the current picture for display, wherein the first effect image is an image obtained after the server performs the first effect processing on the initial image.

2. The method according to claim 1, wherein transmitting the initial image to the server to cause the server to perform the first effect processing on the initial image comprises:
transmitting the initial image carrying an algorithm identifier to the server, to cause the server to invoke a target effect algorithm according to the algorithm identifier to perform the first effect processing on the initial image using the target effect algorithm.

3. The method according to claim 1, wherein the material is composed of a sequence of material images; and
wherein rendering the material onto the current picture for display comprises:
rendering the sequence of material images onto the current picture sequentially for display.

4. The method according to claim 1, wherein receiving the first effect image transmitted by the server and rendering the first effect image onto the current picture for display comprise:
continuing, in response to determining that the material is not completely displayed when the first effect image transmitted by the server is received, rendering the material onto the current picture; and
rendering, in response to determining that the material is completely displayed, the first effect image onto the current picture for display.

5. The method according to claim 1, wherein receiving the first effect image transmitted by the server and rendering the first effect image onto the current picture for display comprise:
in response to determining that the material is not completely displayed when the first effect image transmitted by the server is received, stopping rendering the material and rendering the first effect image onto the current picture for display.

6. The method according to claim 1, wherein receiving the first effect image transmitted by the server and rendering the first effect image onto the current picture for display comprise:
in response to determining that the first effect image transmitted by the server is not received when the material is completely displayed, keeping the current picture still at the material for a duration, or acquiring the material again and displaying the material for the duration on the current picture; and
rendering, in response to determining that the first effect image transmitted by the server is received within the duration, the first effect image onto the current picture for display.

7. The method according to claim 6, further comprising:
in response to determining that the first effect image transmitted by the server is not received within the duration, rendering the initial image onto the current picture for display or displaying information on the current picture.

8. The method according to claim 6, wherein after obtaining the initial image, the method further comprises:
performing second effect processing on the initial image so as to obtain a second effect image; and
rendering, in response to determining that the first effect image transmitted by the server is not received within the duration, the second effect image onto the current picture for display.

9. The method according to claim 8, wherein performing the second effect processing on the initial image so as to obtain the second effect image comprises:
dividing a region in the initial image so as to obtain a sub-region; and
performing the second effect processing on the sub-region so as to obtain a second effect image.

10. The method according to claim 1, wherein before taking the screenshot of the current picture, the method further comprises:
running a beautification program package to beautify a collected image; and
rendering the beautified image onto the current picture; and
wherein taking the screenshot of the current picture comprises:
taking the screenshot of the beautified image in the current picture.

11. (canceled)

12. An electronic device, comprising:
one or more processors; and
a storage, configured to store one or more programs; wherein
the one or more programs, when executed by the one or more processors, cause the one or more processors to:
take, in response to detecting an operation triggered by a user, a screenshot of a current picture so as to obtain an initial image;
transmit, to a server, the initial image to cause the server to perform first effect processing on the initial image, and render a material onto the current picture for display; and
receive a first effect image transmitted by the server, and render the first effect image onto the current picture for display, wherein the first effect image is an image obtained after the server performs the first effect processing on the initial image.

13. A non-transitory storage medium, comprising a computer-executable instruction, wherein the computer-executable instruction, when executed by a computer processor, causes the computer processor to:
take, in response to detecting an operation triggered by a user, a screenshot of a current picture so as to obtain an initial image;
transmit, to a server, the initial image to cause the server to perform first effect processing on the initial image, and render a material onto the current picture for display; and
receive a first effect image transmitted by the server, and render the first effect image onto the current picture for display, wherein the first effect image is an image obtained after the server performs the first effect processing on the initial image.

14. The electronic device according to claim 12, wherein the one or more processors, when caused to transmit the initial image to the server to cause the server to perform the first effect processing on the initial image comprises, are to:
transmit the initial image carrying an algorithm identifier to the server, to cause the server to call a target effect algorithm according to the algorithm identifier to perform the first effect processing on the initial image using the target effect algorithm.

15. The electronic device according to claim 12, wherein the material is composed of a sequence of material images; and
wherein the one or more processors, when caused to render the material onto the current picture for display, are to:
render the sequence of material images onto the current picture sequentially for display.

16. The electronic device according to claim 12, wherein the one or more processors, when caused to receive the first effect image transmitted by the server and render the first effect image onto the current picture for display, are to:
continue, in response to determining that the material is not completely displayed when the first effect image transmitted by the server is received, rendering the material onto the current picture; and
render, in response to determining that the material is completely displayed, the first effect image onto the current picture for display.

17. The electronic device according to claim 12, wherein the one or more processors, when caused to receive the first effect image transmitted by the server and render the first effect image onto the current picture for display, are to:
in response to determining that the material is not completely displayed when the first effect image transmitted by the server is received, stop rendering the material and render the first effect image onto the current picture for display.

18. The electronic device according to claim 12, wherein the one or more processors, when caused to receive the first effect image transmitted by the server and render the first effect image onto the current picture for display, are to:
in response to determining that the first effect image transmitted by the server is not received when the material is completely displayed, keep the current picture still at the material for a duration, or acquire the material again and display the material for the duration on the current picture; and
render, in response to determining that the first effect image transmitted by the server is received within the duration, the first effect image onto the current picture for display.

19. The electronic device according to claim 18, wherein the one or more programs, when executed by the one or more processors, further cause the one or more processors to in response to determining that the first effect image transmitted by the server is not received within the duration, render the initial image onto the current picture for display or display information on the current picture.

20. The electronic device according to claim 18, wherein the one or more programs, when executed by the one or more processors, further cause the one or more processors to after obtaining the initial image:
perform second effect processing on the initial image so as to obtain a second effect image; and
render, in response to determining that the first effect image transmitted by the server is not received within the duration, the second effect image onto the current picture for display.

21. The electronic device according to claim 20, wherein the one or more processors, when caused to perform the second effect processing on the initial image so as to obtain the second effect image, are to:
divide a region in the initial image so as to obtain a sub-region; and
perform the second effect processing on the sub-region so as to obtain a second effect image.
